(19) United States
(12) Patent Application Publication
(10) Pub. No.: US 2026/0283906 A1
(43) Pub. Date: Sep. 24, 2026

(54) MODULAR SMART MEDICATION DISPENSING AND TRACKING CABINET

(71) Applicant: MEDSENSE HEALTH, INC., Tacoma, WA (US)

(72) Inventors: Clark Emerick, Kirkland, WA (US); Matthew Tabakin, Tacoma, WA (US)

(21) Appl. No.: 19/573,736

(22) Filed: Mar. 20, 2026

Related U.S. Application Data
(60) Provisional application No. 63/870,981, filed on Aug. 27, 2025.
(60) Provisional application No. 63/775,295, filed on Mar. 21, 2025.

(51) Int. Cl. A61J 7/00; A61J 7/02

(52) U.S. Cl. CPC A61J 7/0076; A61J 7/02

(57) ABSTRACT

A medication dispenser assembly is provided. The medication dispenser assembly includes a front wall, a lower portion, and an upper wall. The lower portion is fixedly connected to the front wall. The upper portion is pivotably mounted to the front wall. The upper portion and the lower portion define a passage in communication with an opening in the front wall. The upper portion includes a sensor configured to detect a strip of medication packets moving through the passage.

### CROSS REFERENCE TO RELATED APPLICATIONS

This application claims priority to U.S. Provisional Patent Application No. 63/775,295, filed March 21, 2025, and to U.S. Provisional Patent Application No. 63/870,981 filed August 27, 2025, the entire disclosures of which are incorporated by reference herein.

### BACKGROUND

Medication adherence is a critical challenge in senior living communities, rehabilitation centers, and healthcare facilities. Failure to take medications correctly can lead to hospitalizations, adverse drug reactions, and poor health outcomes. Existing medication storage solutions lack real-time tracking, automated dispensing, and secure digital monitoring.

Further, patients using pill strip packaging often require integration with reader devices that monitor medication adherence. Existing refill systems are limited by proprietary dimensions and lack modularity.

### SUMMARY

Some embodiments provide a medication dispenser assembly, that includes a front wall, a lower portion, and an upper wall. The lower portion is fixedly connected to the front wall. The upper portion is pivotably mounted to the front wall. The upper portion and the lower portion define a passage in communication with an opening in the front wall. The upper portion includes a sensor configured to detect a strip of medication packets moving through the passage.

In some embodiments, the upper portion has a tear-off plate extending through an outer housing and configured to pinch the strip of medication packets against the lower portion.

In some embodiments, the tear-off plate is slidably supported in an inner housing mounted in the outer housing.

In some embodiments, the tear-off plate has a guide tab slidably disposed within a guide slot of the inner housing.

In some embodiments, a retainer tab extends into the inner housing and the outer housing to fix the inner housing in the outer housing.

In some embodiments, the sensor is contained in a sensor carrier rotatably engaged with an outer housing of the upper portion.

In some embodiments, the sensor carrier is slidably and rotatably mounted in a bridge mounted in the outer housing.

In some embodiments, a spring mounted in the outer housing urges the sensor carrier away from the outer housing.

In some embodiments, the spring and an axle of the sensor carrier a disposed in a pocket defined in the bridge.

In some embodiments, the axle extends from a spool, the spool is greater in diameter than the axle, and the spool retains the spring in the pocket.

In some embodiments, a magnet mounted in the lower portion magnetically attracts a ferromagnetic fastener mounted in the upper portion to hold the upper portion in a closed configuration relative to the lower portion.

In some embodiments, a chamber assembly includes the front wall, the chamber assembly is configured to house the strip of medication packets.

In some embodiments, the chamber assembly includes a side wall removably connected to the front wall.

In some embodiments, the side wall is a first side wall, and the chamber assembly includes a peg mounted to the first side wall and a second side wall.

In some embodiments, a guide protrusion extends from the front wall opposite the upper portion.

Some embodiments provide a medication dosing system that includes a controller and a plurality of medication dispenser assemblies. The controller is in communication with a remote computing device via a network. Each medication dispenser assembly includes a front wall, a lower portion, and an upper portion. The lower portion is fixedly connected to the front wall. The upper portion is pivotably mounted to the front wall. The upper portion and the lower portion define a passage in communication with an opening in the front wall. The upper portion includes a sensor configured to detect a strip of medication packets moving through the passage.

In some embodiments, the plurality of medication dispenser assemblies are mounted in a cabinet, and the plurality of medication dispenser assemblies communicate with the controller via a communication hub mounted to the cabinet.

In some embodiments, each medication dispenser assembly is configured to house a strip of medication packets, count a number of medication packets pulled through the passage, and communicate the number of medication packets to the controller.

Some embodiments provide a medication dispenser assembly that includes a front guide track, a lower partition, and an upper portion. The lower portion is fixedly connected to the front guide track and a lower guide track. The upper portion is pivotably mounted to the front guide track. The upper portion and the lower portion define a passage in communication with an opening in the front guide track. The upper portion includes a sensor configured to detect a strip of medication packets moving through the passage.

In some embodiments, the front and lower guide tracks are configured to retain a box.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of a medication dosing system, according to an embodiment;

FIG. 2, is a side view of a cabinet of the medication dosing system of FIG. 1;

FIG. 3 is an enlarged view of region A of FIG. 1;

FIG. 4 is an enlarged view of region B of FIG. 1;

FIG. 5 is an enlarged view of region C of FIG. 1

FIG. 6 is an isometric view of a first medication dispenser assembly of the medication dosing system of FIG. 1, according to an embodiment;

FIG. 7 is an isometric view of a medication reader of the medication dispenser assembly of FIG. 6;

FIG. 8 is another isometric view of the medication reader of FIG. 7;

FIG. 9 is a top view of the medication reader of FIG. 7;

FIG. 10 is an exploded view of the medication reader of FIG. 7;

FIG. 11 is a cross sectional view of the medication reader of FIG. 7 taken along line D-D of FIG. 7;

FIG. 12 is another cross sectional view of the medication reader of FIG. 7 taken along line E-E of FIG. 7;

FIG. 13 is a further cross sectional view of the medication reader of FIG. 7 taken along line F-F of FIG. 7;

FIG. 14 is an isometric view of a second medication dispenser assembly useable with the medication dosing system of FIG. 1, according to an embodiment;

FIG. 15 is an isometric view of a third medication dispenser assembly useable with the medication dosing system of FIG. 1, according to an embodiment, in a closed configuration; and

FIG. 16 is an isometric view of the third medication dispenser assembly of FIG. 15 in an open configuration.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers’ specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

The present invention relates to medication adherence and dispensing technology, and more specifically to a refillable pill strip reader housing and frame system that allows for modular, adaptable, and user-friendly loading of pill strip packaging.

This disclosure integrates SmartBox technology with a modular cabinet system, enabling secure medication storage, automated dispensing, and real-time adherence tracking. The solution features adjustable shelving, integrated power, a pill strip reader system, and a digital adherence tracking mechanism to improve patient care and medication safety.

When a medication is dispensed from a SmartBox, sensor data travels from a sensor to a hub and then over a network to remote computing device. In response to the sensor data, the remote computing device creates an action for a user person dispensing the medication. The action may include prompting the user to confirm the number of doses, to identify the patient receiving the medication, and/or to provide a user identification. In some embodiments, the user fills out this information via a tablet stand. The information is used to populate a Medication Administrative Record (MAR).

This disclosure provides a universal refill housing system that allows for compatibility across multiple pill strip formats while simplifying the reloading process.

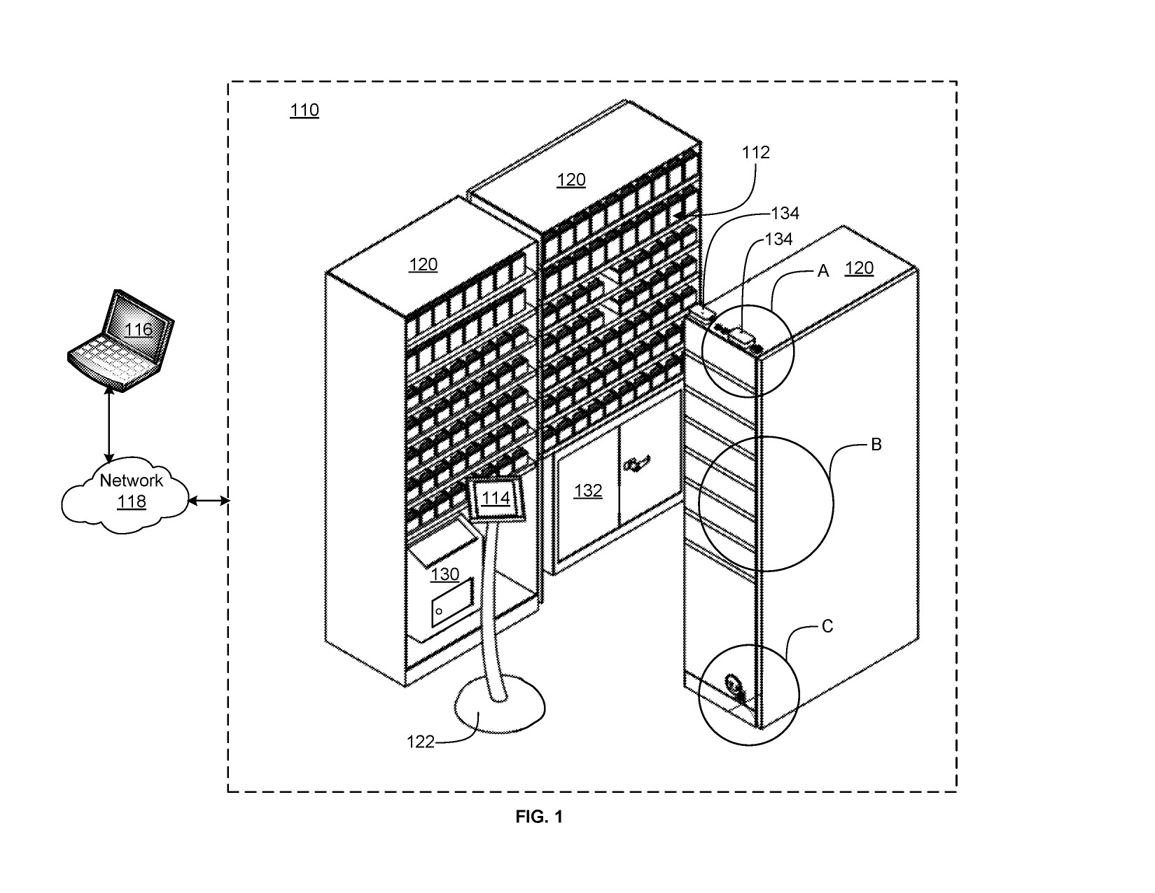

FIG. 1 illustrates a medication dosing system 110 including a plurality of medication dispenser assemblies 112 in communication with a controller 114. The medication dosing system 110 is in communication with a remote computing device 116 via a network 118. The plurality of medication dispenser assemblies 112 are mounted to and/or housed in one or more cabinets 120. The medication dispenser assemblies 112 may vary in size to contain and dispense differing amounts of supplies of medication (e.g., a 14 days supply, a 30 day supply, etc.). In some embodiments, the controller 114 is mounted to a pedestal 122.

Referring again to FIG. 1, in some embodiments, the cabinets 120 further house a lock box 130 and/or secured storage 132. Further, one or more of the cabinets 120 supports one or more communication hubs 134. More specifically, the controller 114 is in communication with the medication dispenser assemblies 112 via one or more of the communication hubs 134. The medication dosing system 110 is in communication with the network 118 via the controller 114 and/or one or more of the communication hubs 134. Additional communication hubs 134 may be installed in a building to support additional medication dispenser assemblies 112.

In operation, in some embodiments, the medication dosing system 110 tracks medication adherence, logs real-time dosage events, and transmits medication adherence data to caregivers and healthcare providers. Further, in some embodiments, the medication dosing system 110 detects and logs unauthorized access attempts. Additionally, in some embodiments, the medication dosing system 110 documents when medications are administered. In some embodiments, the medication dosing system 110 also provides alerts to users when a dose needs to be taken, was missed and/or was taken outside of a prescribed time window. It should be understood that the cabinets 120 may house medical monitoring devices in addition to the medication dispenser assemblies 112 that are in communication with the communication hubs 134 (e.g., sensors for bottles, sensors for inhalers, blister monitoring solutions, etc.). Further, the cabinets 120 may house barcode scanning equipment that is in communication with the communication hubs 134. The medication dispenser assemblies 112, additional medical monitoring devices, and barcode scanning equipment are configured to produce information to generate a MAR.

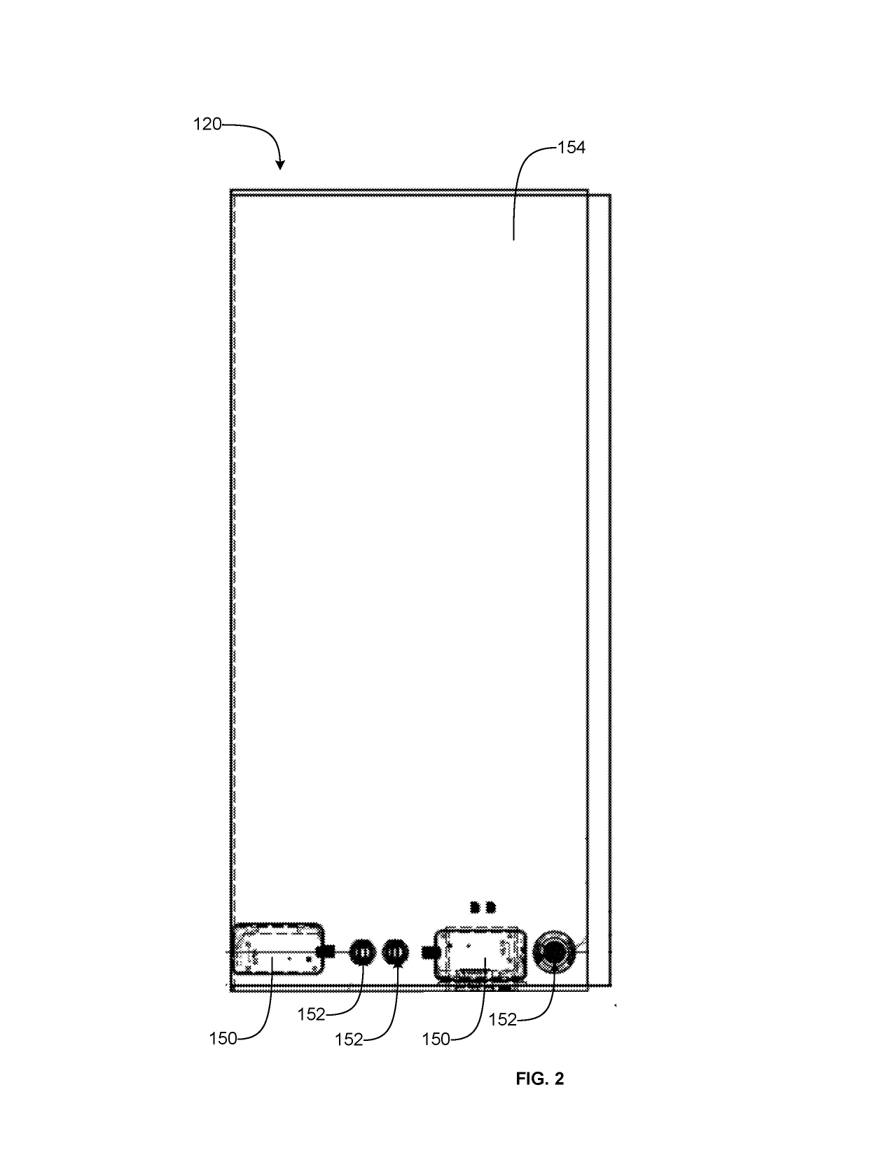

As shown in FIG. 2, in some embodiments, the cabinet 120 houses one or more uninterrupted power supplies (UPS) 150 that supply power to the medication dispenser assemblies 112 in the event of a power outage. Further, the cabinet 120 may define ventilation openings 152 defined in a first side panel 154a. The UPS 150 is in communication with the communication hubs 134 (shown in FIG. 1). In some instances, for redundancy, a plurality (e.g., two or more) communication hubs 134 are connected to the UPS 150.

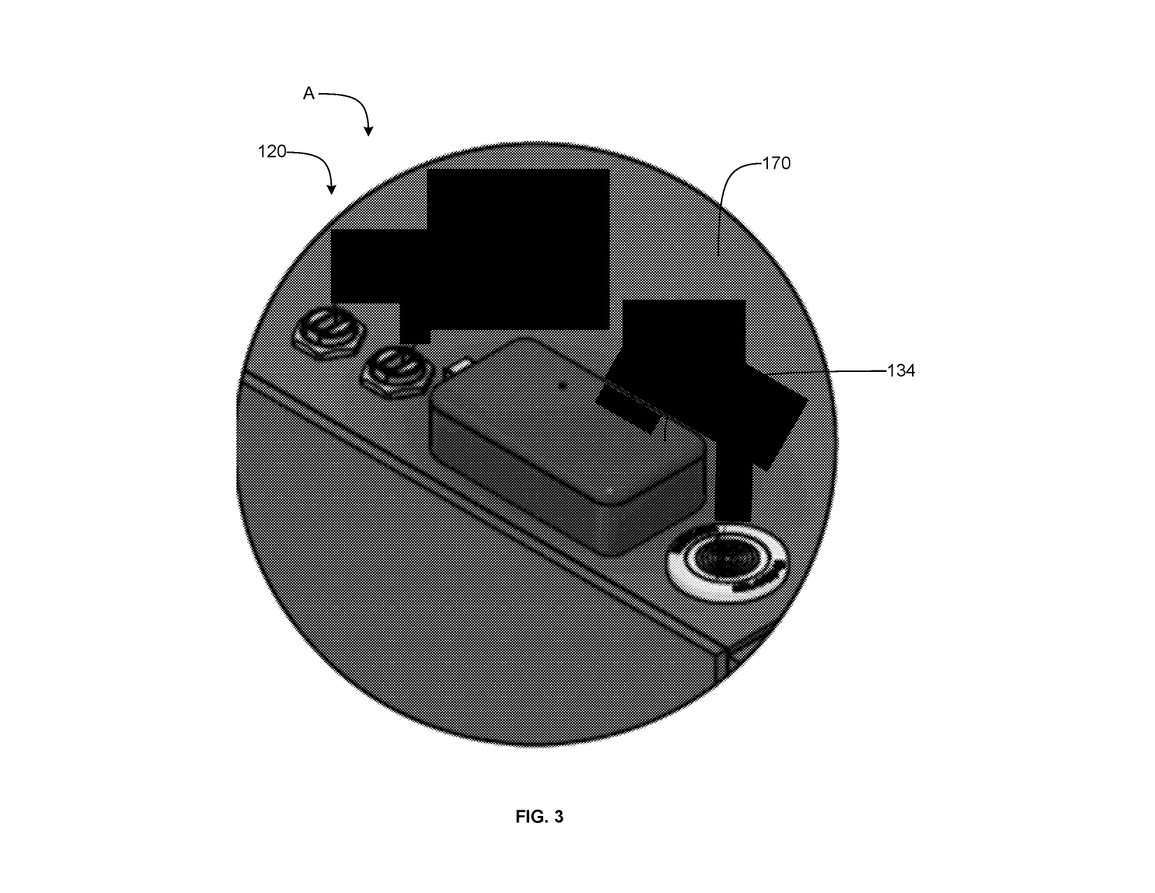

With reference to FIG. 3, in some embodiments, the communication hubs 134 are mounted in a top panel 170 of the cabinet 120.

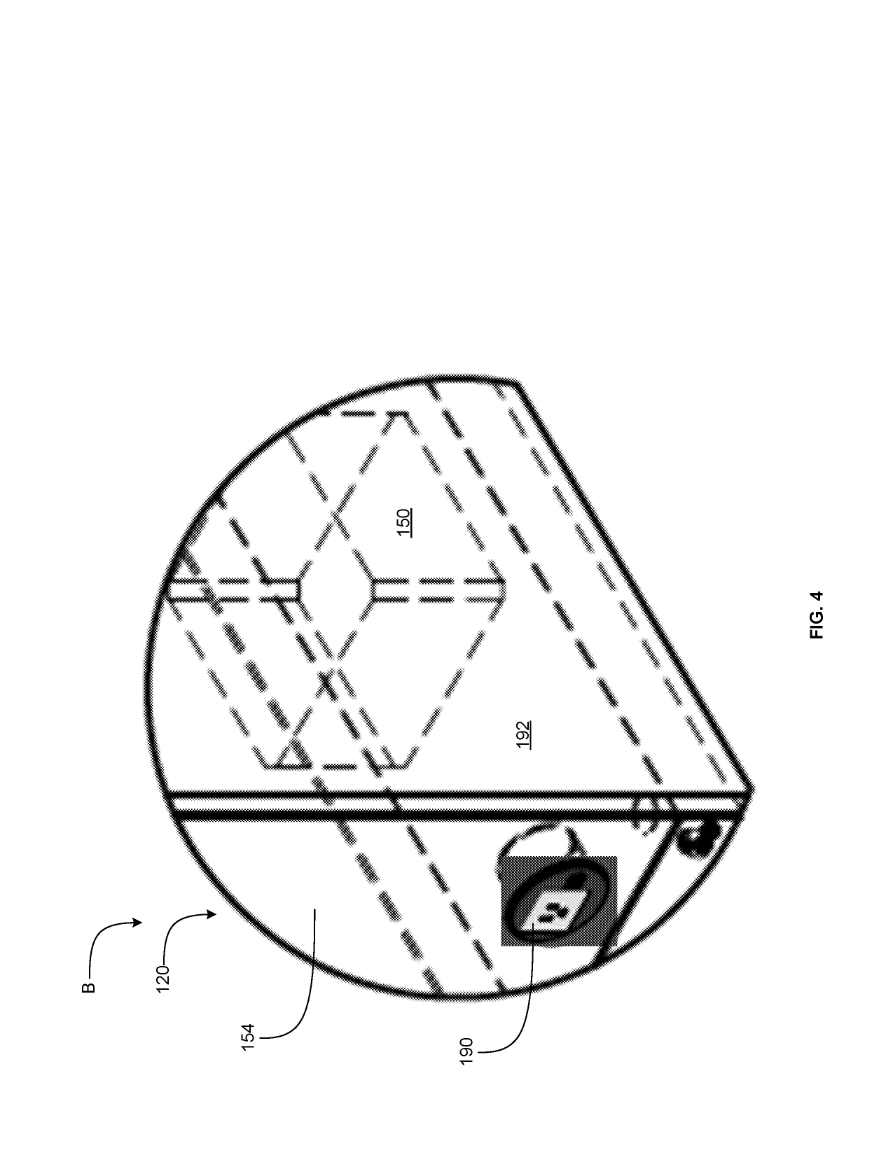

With reference to FIG. 4, in some embodiments, a power supply socket 190 is mounted in a second side panel 154b of the cabinet 120. Further, the uninterrupted power supply 150 is mounted to a bottom shelf 192 (shown in phantom) of the cabinet 120.

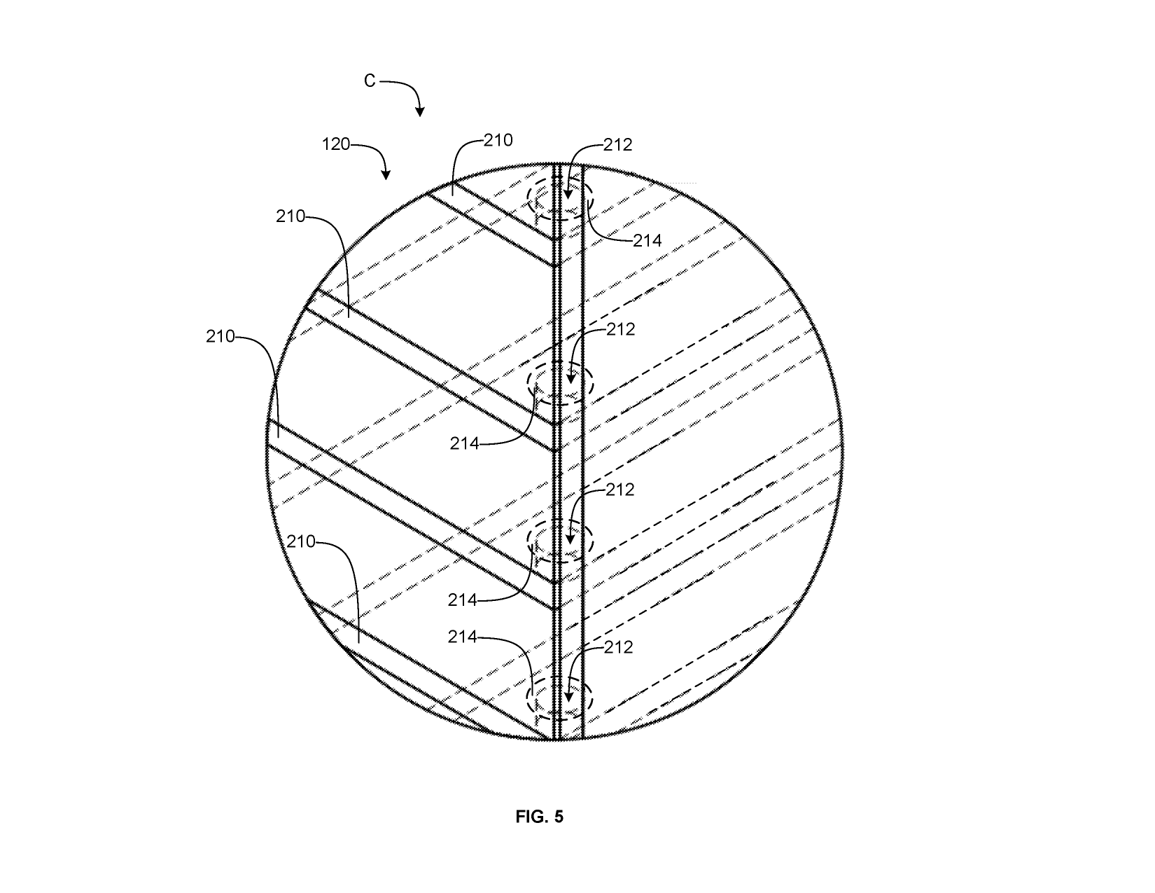

With reference to FIG. 5, intermediary shelves 210 (shown in phantom) define openings 212 through which electrical wires (not shown) pass to provide power and communication to the medication dispenser assemblies 112. In some embodiments, grommets 214 are respectively mounted in the openings 212 to protect the electrical wires.

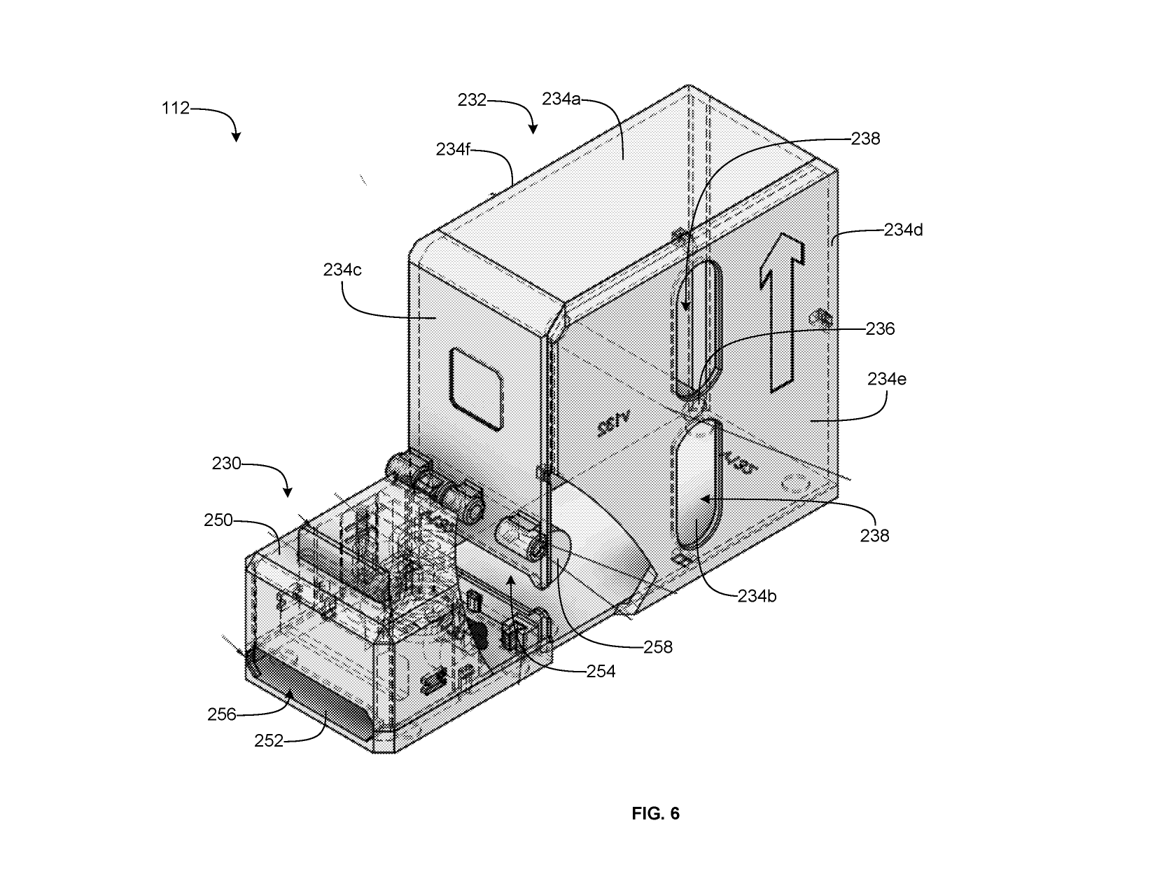

With reference to FIG. 6, the medication dispenser assembly 112 includes a medication reader 230 mounted to a chamber assembly 232. The chamber assembly 232 is generally rectilinear and thus includes upper, lower, front, rear, and first and second side walls 234a-f connected to one another. In some embodiments, one or more of the first and second side walls 234e, f is removably connected to the upper, lower, front, and rear walls 234a-d. In some embodiments, a peg 236 (shown in phantom) is mounted medially along the first and second side walls 234e, f. In operation, a strip of medication packets wound into a spool (not shown) may be rotatably supported by the peg 236. One or more of the first and second side walls 234e, f may define windows 238 through which the medication spool may be seen.

Remaining with FIG. 6, an upper portion 250 of the medication reader 230 is pivotably mounted to the front wall 234c. A lower portion 252 is fixedly mounted (e.g., via dovetails) to the front wall 234c. The front wall 234 defines an opening 254. The medication reader 230 defines a passage 256 in communication with the opening 254. In operation, the medication reader 230 counts the number of medication packets dispensed from the the passage 256 as the strip of medication packets is pulled through the opening 254 and the passage 256, as will be explained in greater detail below. A guide protrusion 258 extends from the front wall 234c opposite the medication reader 230 into a chamber 260 defined by the chamber assembly 232. In operation, the guide protrusion 258 aids in directing the strip of medication packets through the opening 254. Additionally, pivot hinges 262 extend outwardly from the front wall 234c to pivotably connect with the upper portion 250. Thus, the upper portion 250 may be pivotably opened relative to the lower portion 252 (e.g., to feed that strip of medication packets through the medication reader 230.

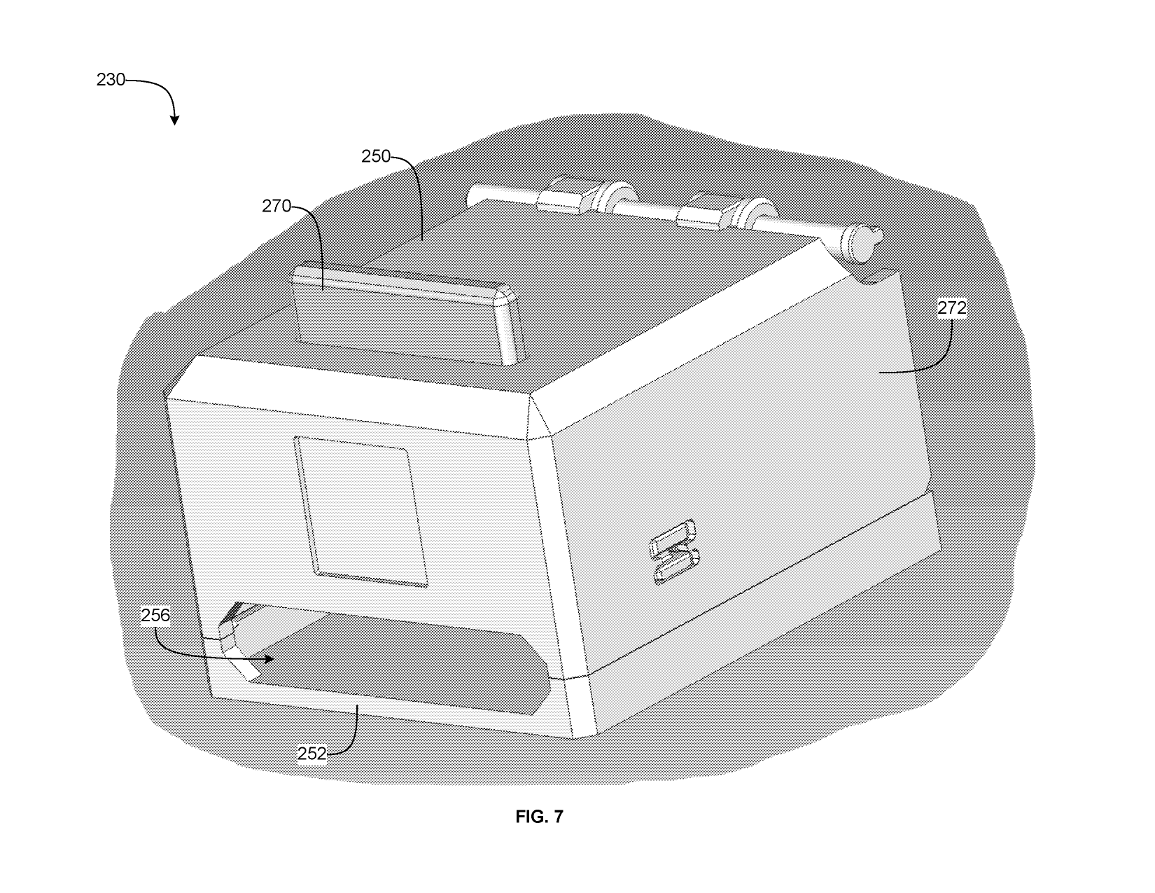

With reference to FIG. 7, the upper portion 250 and the lower portion 252 define the passage 256. The upper portion 250 is removably attached to the lower portion 252. In some embodiments, the lower portion 252 is trough shaped. A tear-off plate 270 extends slidably through an outer housing 272 of the upper portion 250.

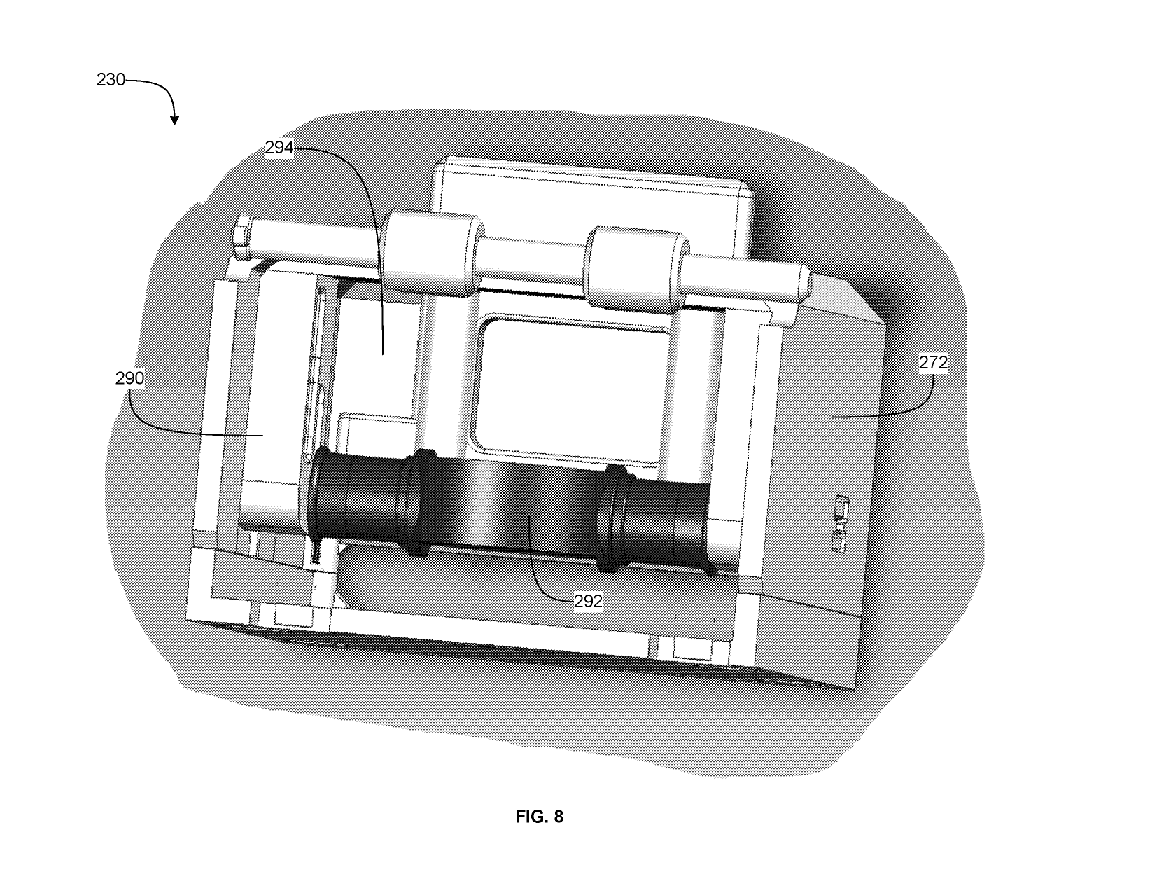

Turning to FIG. 8, a bridge 290 snapably mounts into the outer housing 272 and rotatably and slidably supports a sensor carrier 292. An inner housing 294 also mounts into the outer housing 272 and slidably supports the tear-off plate 270.

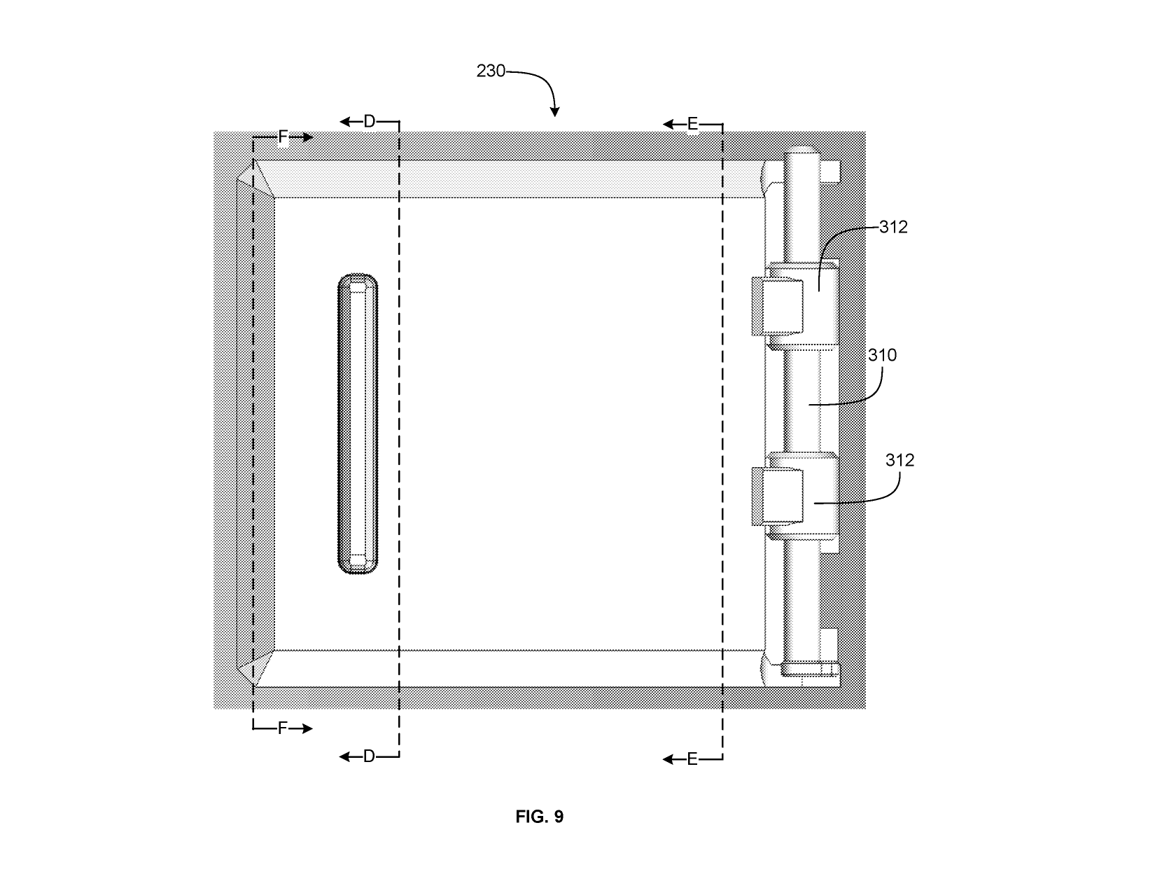

With reference to FIG. 9, a pivot axle 310 extends through pivot hinges 312 extending from the outer housing 272.

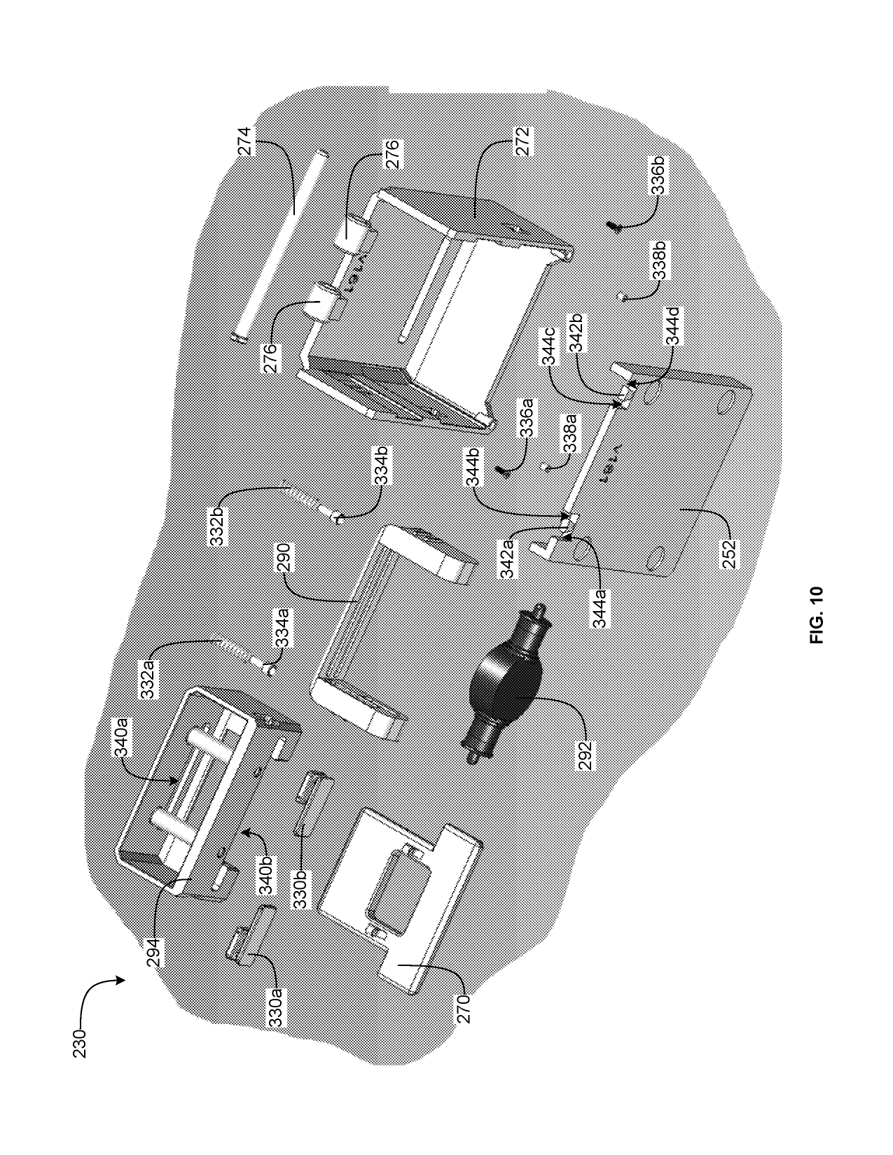

With reference to FIG. 10, the medication reader 230 further includes first and second retainer tabs 330a, b that connect the inner housing 294 to the outer housing 272. Additionally, first and second plungers 332a, b and first and second springs 334a, b, respectively urge the sensor carrier 292 towards the lower portion 252 within the bridge 290. First and second fasteners 336a, b mount into the outer housing 272 and are formed of a ferromagnetic material (e.g., iron, steel, etc.). First and second magnets 338a, b mount into the lower portion and respectively attract the first and second fasteners 336a, b, thus removably connecting the outer housing 272 to the lower portion 252. Further, the inner housing 294 defines upper and lower slots 340a, b through which the tear-off plate 270 extends. The lower portion 252 includes first and second dovetail tails 342a, b and defines corresponding dovetail sockets 344a-d. The lower portion 252 thus interlockingly connects to the lower wall 234b (shown in FIG. 6) via first and second dovetail tails 342a, b and defines corresponding dovetail sockets 344a-d.

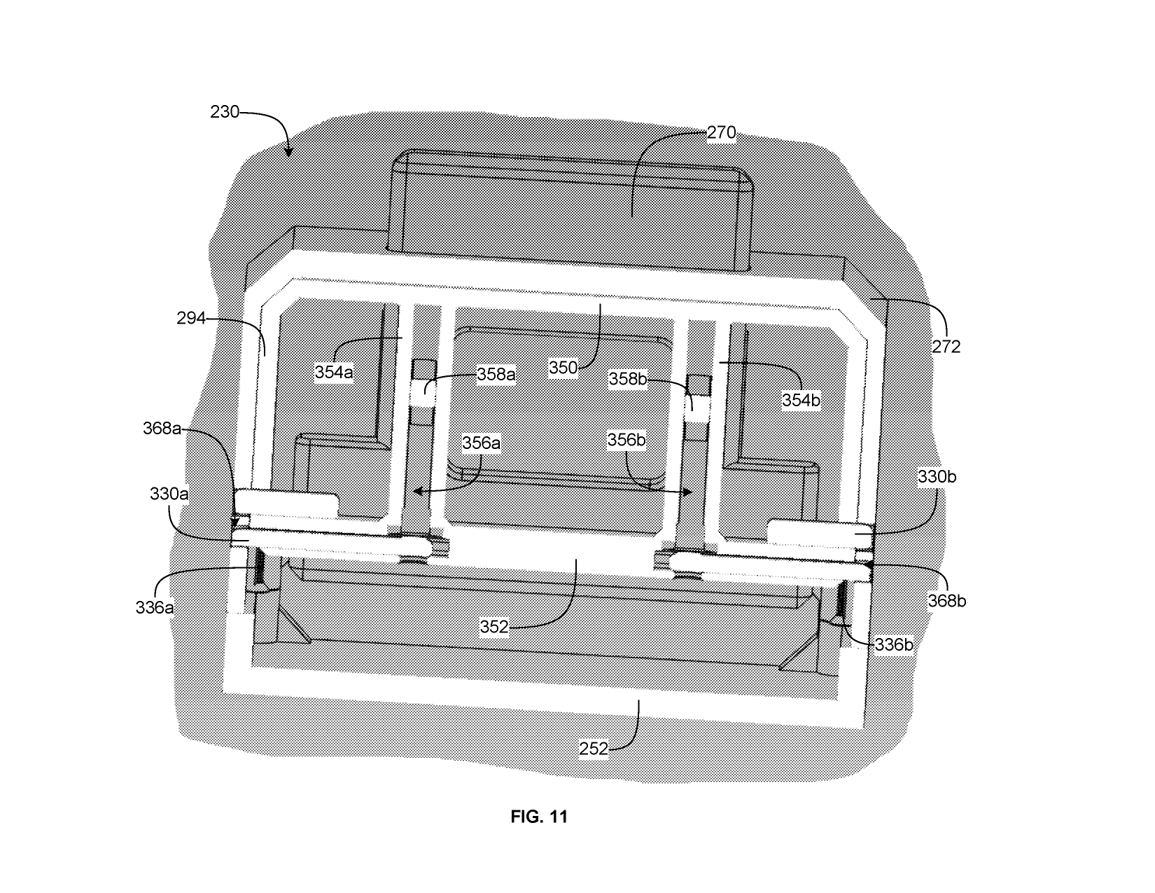

With reference to FIG. 11, the inner housing 294 includes an arch portion 350 extending from a base 352. First and second guide posts 354a, b extend between the arch portion 350 and the base 352 and respectively define first and second guide slots 356a, b. First and second guide slot tabs 358a, b extend from the tear-off plate 270 into the first and second guide slots 356a, b and slidably engage the first and second guide posts 354a, b.

Remaining with FIG. 11, the first and second retainer tabs 330a, b slidably insert into the inner housing 294. When mounted into the inner housing 294, the first and second retainer tabs 330a, b protrude outwardly from the inner housing 294 and are snapably received by the outer housing 272 via first and second openings 368a, b. The first and retainer tabs 330a, b further extend into the first and second guide slots 356a, b, respectively. Thus, sliding movement of the first and second guide slot tabs 358a, b is delimited between the arch portion 350 and the first and second retainer tabs 330a, b.

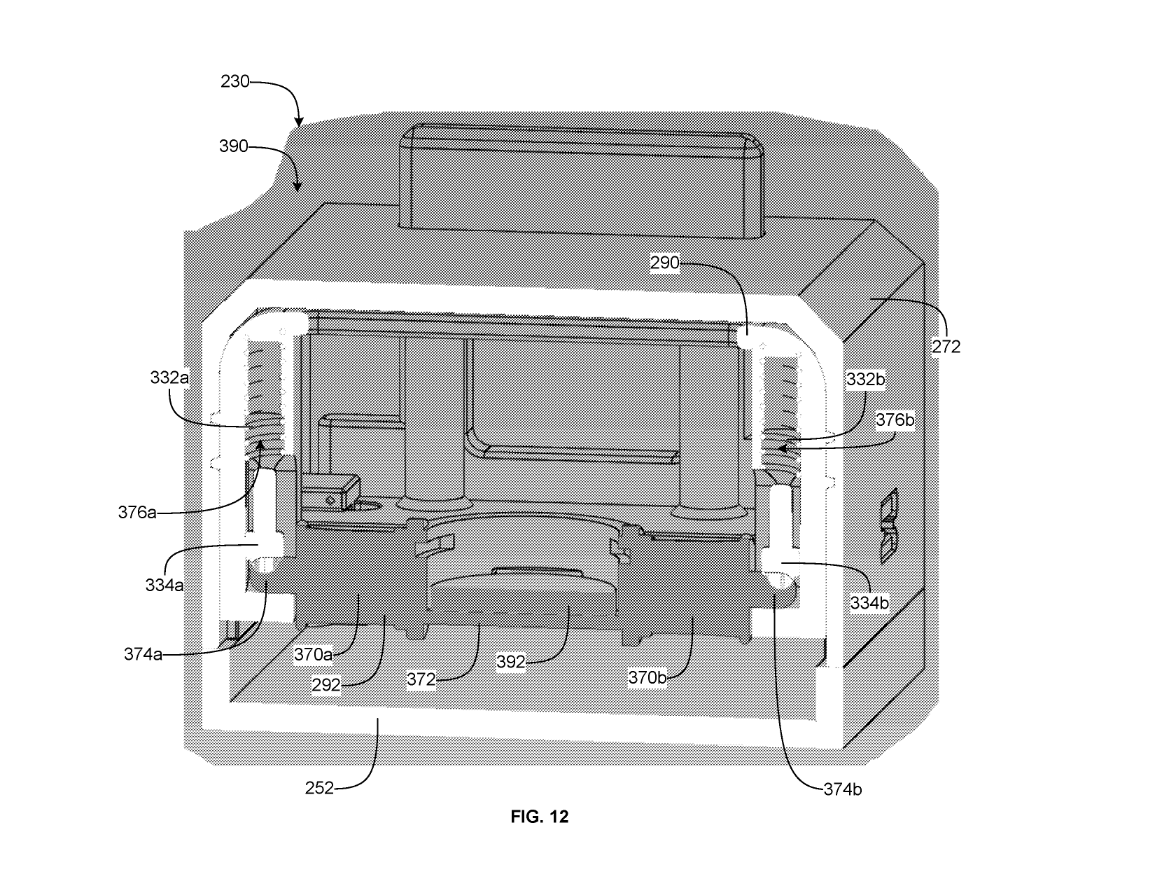

Turning to FIG. 12, first and second spools 370a, b extend outwardly from a cup 372 of the sensor carrier 292. Further, first and second axles 374a, b extend outwardly from the first and second spools 370a, b, respectively. The bridge 290 defines first and second pockets 376a, b in which the first and second springs 334a, b are disposed, respectively. Additionally, the first and second plungers 332a, b, and the first and second axles 374a, b are slidably captured within the first and second pockets 376a, b, respectively. The first and second axles 374a, b are further rotatably engaged with the bridge 290 via the first and second pockets 376a, b, respectively.

Referring again to FIG. 12, the first and second axles 374a, b rotatably and slidably bear against the first and second plungers 332a, b, respectively. The first and second spools 370a, b are larger in diameter than the first and second axles 374a, b, respectively. Thus, the first and second spools 370a, b slidably engage the bridge 290 to retain the first and second springs 334a, b and the first and second plungers 332a, b in the first and second pockets 376a, b, respectively.

Remaining with FIG. 12, the first and second springs 334a, b urge the first and second plungers 332a, b against the first and second axles 374a, b. Thus, the first and second springs 334a, b urge the sensor carrier 292 away from the outer housing 272. In a closed configuration 390, the first and second springs 334a, b thus urge the sensor carrier 292 toward the lower portion 252. Additionally, the cup 372 houses a sensor 392 (e.g., optical, accelerometer, etc.). The sensor 392 is in communication with the controller 114 via one or more of the communication hubs 134 (shown in FIG. 1). In operation, the sensor carrier 292 is urged against the strip of medication packets in the passage 256. As the strip of medication packets is pulled through the passage 256, the packets engage and rotate the sensor carrier 292 and thus the sensor 392 within. The sensor 392 counts the number of rotations, which correspond to the number of medication packets dispensed from the medication reader 230. Further in operation, a user may depress the tear-off plate 270 to pinch the strip of medication packets against the lower portion 252 and tear the dosed medication packets from the remaining spool at the tear-off plate 270.

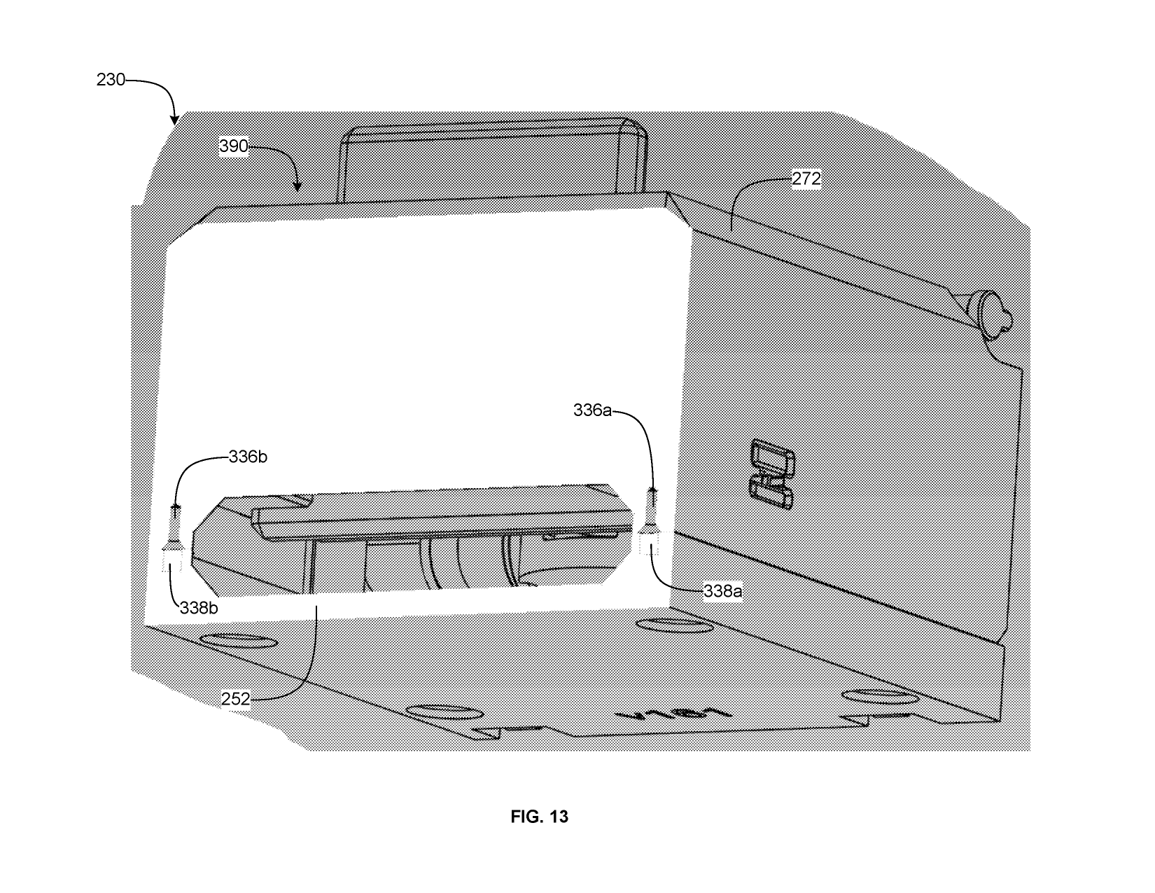

With reference to FIG. 13, the first and second magnets 338a, b are mounted in the lower portion 252. The first and second fasteners 336a, b are mounted in the outer housing 272 to engage the first and second magnets 338a, b, respectively. The first and second magnets 338a, b magnetically attract the first and second fasteners 336a, b to hold the upper portion 250 in the closed configuration 390 relative to the lower portion 252.

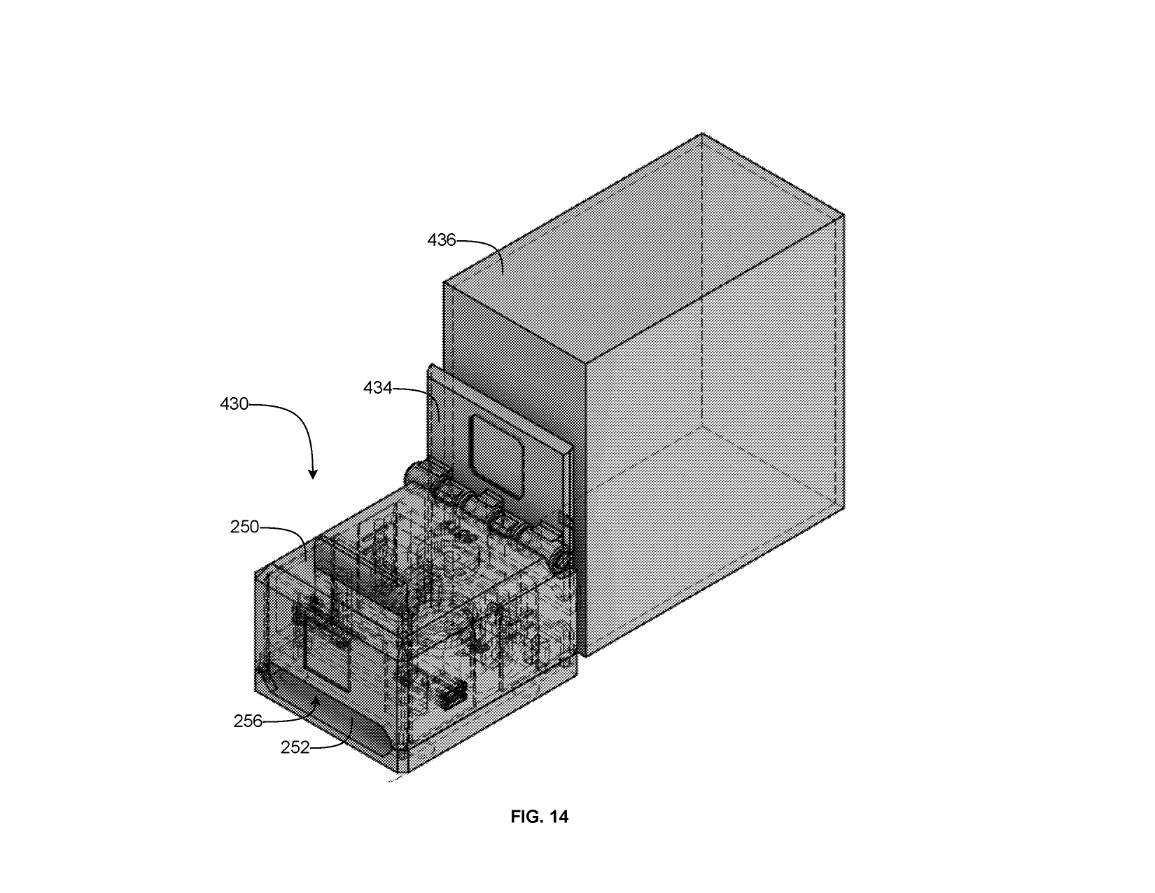

With reference to FIG. 14, a medication reader 430 includes the upper portion 250, the lower portion 252, and a mounting wall 434. The upper portion 250 is pivotably connected to the mounting wall 434. The lower portion 252 is fixedly connected to the mounting wall 434 (e.g., interlockingly). Thus, the upper portion 250 is openable relative to the lower portion 252. The mounting wall 434 is configured to attach to a medication box 436 that contains a strip of medication packets (e.g., wound into a spool, folded in deployable serpentine layers, etc.). In operation, the medication reader 430 counts the number of medication doses pulled through the passage 256.

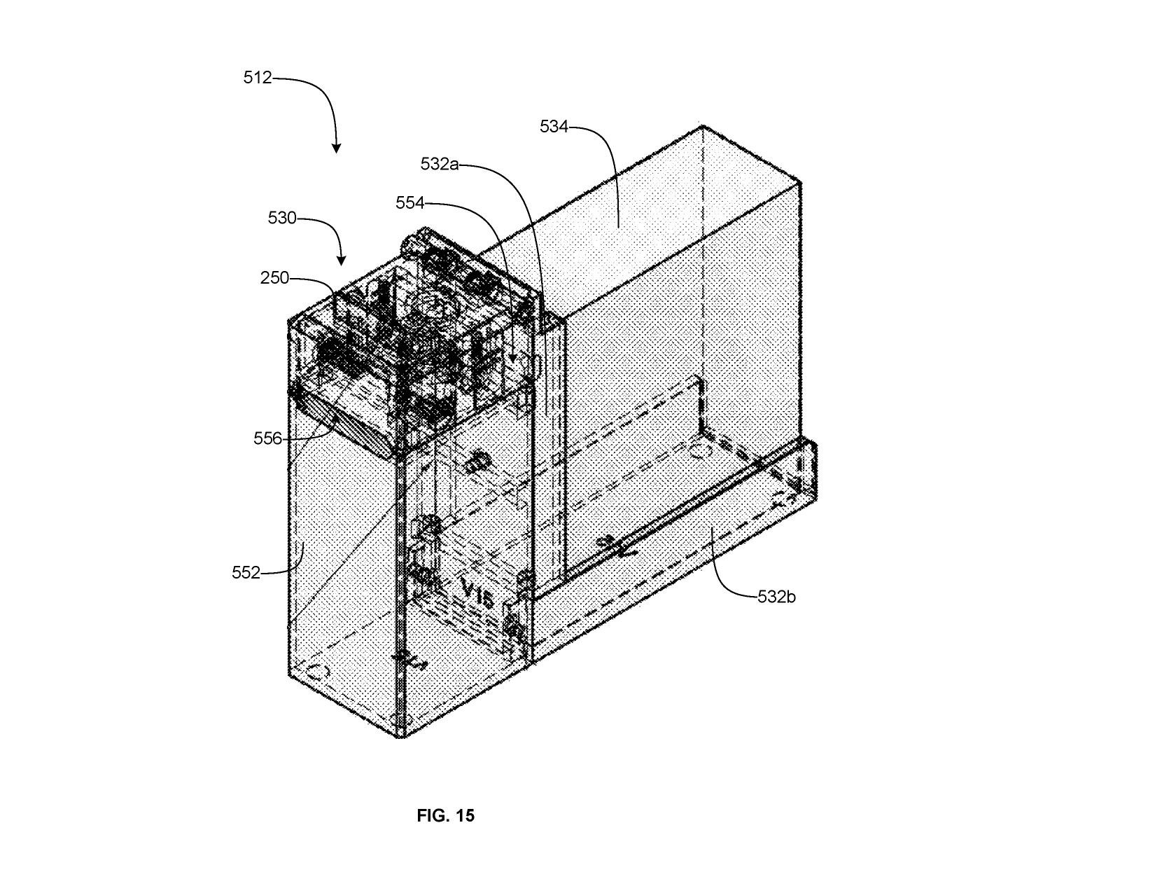

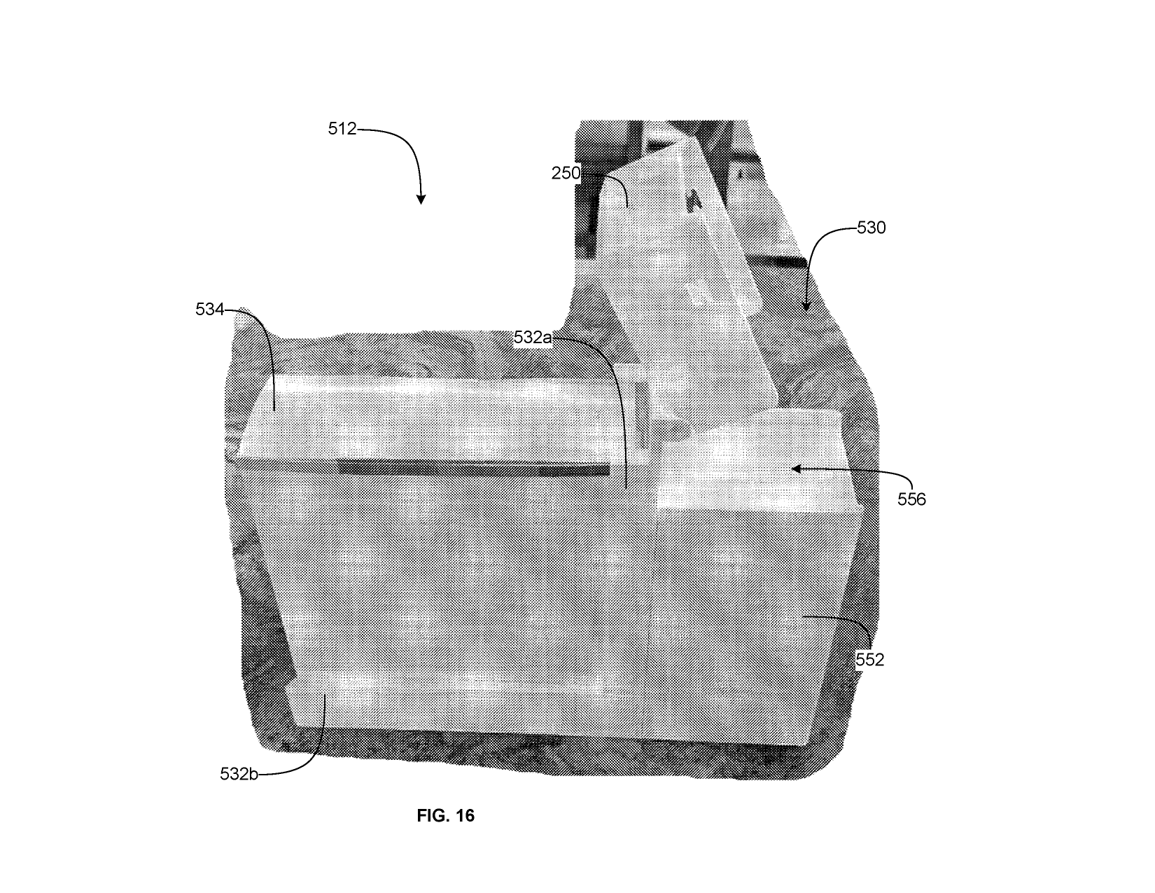

With reference to FIG. 15, a medication dispenser assembly 512 includes a medication reader 530 mounted to front and lower guide tracks 532a, b. The medication reader 530 includes the upper portion 250 pivotably mounted to the front guide track 532a and a lower portion 552 fixedly mounted to the front and lower guide tracks 532a, b. The front guide track 532a defines an opening 554 (shown in phantom). The upper portion 250 and the lower portion 552 define a passage 556 in communication with the opening 554. In operation, the strip of medication packets may be dispensed from a box 534 retained in the front and lower guide tracks 532a, b via the opening 554 and the passage 556. As shown in FIG. 16, the upper portion 250 is openable relative to the lower portion 252.

It should be understood that the steps recited in any of the method or process descriptions may be executed in any order and are not limited to the order presented. Further, in some embodiments, one or more of the steps recited in the method or process descriptions may be omitted.

Examples in the present disclosure may also be directed to a non-transitory computer-readable medium storing computer-executable instructions and executable by one or more processors of the computer via which the computer-readable medium is accessed. A computer-readable medium may be any available medium that may be accessed by a computer. By way of example, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The foregoing description, for purposes of explanation, uses specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A medication dispenser assembly, comprising:
a front wall;
a lower portion fixedly connected to the front wall; and
an upper portion pivotably mounted to the front wall, the upper portion and the lower portion defining a passage in communication with an opening in the front wall, the upper portion including a sensor configured to detect a strip of medication packets moving through the passage.

2. The medication dispenser assembly of claim 1, wherein the upper portion has a tear-off plate extending through an outer housing and configured to pinch the strip of medication packets against the lower portion.

3. The medication dispenser assembly of claim 2, wherein the tear-off plate is slidably supported in an inner housing mounted in the outer housing.

4. The medication dispenser assembly of claim 3, wherein the tear-off plate has a guide tab slidably disposed within a guide slot of the inner housing.

5. The medication dispenser assembly of claim 3, wherein a retainer tab extends into the inner housing and the outer housing to fix the inner housing in the outer housing.

6. The medication dispenser assembly of claim 1, wherein the sensor is contained in a sensor carrier rotatably engaged with an outer housing of the upper portion.

7. The medication dispenser assembly of claim 6, wherein the sensor carrier is slidably and rotatably mounted in a bridge mounted in the outer housing.

8. The medication dispenser assembly of claim 7, wherein a spring mounted in the outer housing urges the sensor carrier away from the outer housing.

9. The medication dispenser assembly of claim 8, wherein the spring and an axle of the sensor carrier a disposed in a pocket defined in the bridge.

10. The medication dispenser assembly of claim 9, wherein
the axle extends from a spool,
the spool is greater in diameter than the axle, and
the spool retains the spring in the pocket.

11. The medication dispenser assembly of claim 1, wherein a magnet mounted in the lower portion magnetically attracts a ferromagnetic fastener mounted in the upper portion to hold the upper portion in a closed configuration relative to the lower portion.

12. The medication dispenser assembly of claim 1, wherein
a chamber assembly includes the front wall, and
the chamber assembly is configured to house the strip of medication packets.

13. The medication dispenser assembly of claim 12, wherein the chamber assembly includes a side wall removably connected to the front wall.

14. The medication dispenser assembly of claim 13, wherein
the side wall is a first side wall, and
the chamber assembly includes a peg mounted to the first side wall and a second side wall.

15. The medication dispenser assembly of claim 1, wherein a guide protrusion extends from the front wall opposite the upper portion.

16. A medication dosing system , comprising:
a controller in communication with a remote computing device via a network; and
a plurality of medication dispenser assemblies, each medication dispenser assembly including
a front wall,
a lower portion fixedly connected to the front wall, and
an upper portion pivotably mounted to the front wall, the upper portion and the lower portion defining a passage in communication with an opening in the front wall, the upper portion including a sensor configured to detect a strip of medication packets moving through the passage.

17. The medication dosing system of claim 16, wherein
the plurality of medication dispenser assemblies are mounted in a cabinet, and
the plurality of medication dispenser assemblies communicate with the controller via a communication hub mounted to the cabinet.

18. The medication dosing system of claim 16, wherein each medication dispenser assembly is configured to
house a strip of medication packets,
count a number of medication packets pulled through the passage, and
communicate the number of medication packets to the controller.

19. A medication dispenser assembly, comprising:
a front guide track;
a lower portion fixedly connected to the front guide track and a lower guide track; and
an upper portion pivotably mounted to the front guide track, the upper portion and the lower portion defining a passage in communication with an opening in the front guide track, the upper portion including a sensor configured to detect a strip of medication packets moving through the passage.

20. The medication dispenser assembly of claim 19, wherein the front and lower guide tracks are configured to retain a box.
